(19) United States
(12) Patent Application Publication
(10) Pub. No.: US 2024/0010551 A1
(43) Pub. Date: Jan. 11, 2024

(54) A HEAT TREATABLE DECORATIVE PATTERNED GLASS ARTICLE WITH A SELECTIVELY DISSOLVABLE COATING

(71) Applicant: SAINT-GOBAIN GLASS FRANCE, COURBEVOIE (FR)

(72) Inventors: Jagadis S, CHENNAI, TAMIL NADU (IN); Srinivas Prasad B.S, CHENNAI, TAMIL NADU (IN)

(21) Appl. No.: 18/254,060

(22) PCT Filed: Mar. 8, 2022
(86) PCT No.: PCT/IN2022/050205

§ 371 Date: May 23, 2023

(30) Foreign Application Priority Data
Mar. 11, 2021 (IN) 202141010255

(51) Int. Cl. C03C 17/34

(52) U.S. Cl. CPC C03C 17/3482; C03C 2217/485; C03C 2217/475; C03C 2218/152; C03C 2218/31; C03C 2218/328

(57) ABSTRACT

A heat treatable decorative patterned glass article ha a selectively dissolvable coating. The selectively dissolvable coating is a silicon based monolayer optical coating which is intended to be selectively dissolved in regions underlying a patterned enamel coating during a processing operation of the transparent substrate. The decorative patterned glass article provides excellent contrast to the glass when viewed from the glass side and can withstand the high tempering temperatures during the making of the decorative glass article.

### TECHNICAL FIELD

The present disclosure generally relates to a patterned glass substrate having a selectively dissolvable coating. Specifically, the disclosure relates to a decorative patterned glass article having a selectively dissolvable coating, which can withstand the tempering temperatures during processing of the glass substrates and provide excellent contrast to the glass substrate.

### BACKGROUND

Decorative or patterned coatings on glass substrates are known to have a variety of applications in decorative wall panels, partitions, windows, doors, tables, facades, spandrels etc., in residential or corporate buildings. Decorative patterned glass articles are such articles where a glass substrate is usually deposited or coated or printed or embossed with various appealing patterns or different images, with one or more functional or performance or optical layers. These articles are used not just for their functional purpose, but also provide an aesthetically enhanced appearance to the spaces, by changing the look and feel of the spaces fitted therewith. Such decorative glass articles provide heavenly aesthetics and are highly appealing to customers when provided in different colors and shades.

Specifically, a patterned enamel glass as such is widely used for office and showroom partitioning, up-market homes, washroom basins and bath cubicles, showroom shelves, fridge shelves, doors, decorative uses, restaurant partitioning etc. The designs that are embossed on the patterned enamel glass substrate keep changing as per the changing times and demands of the customers. As mentioned earlier, the patterned glass provides aesthetic decorative benefits. There are several methods in the state of art for fabricating of decorative glass articles. Traditionally known methods include the following:
(i) Deposition of an enamel-based paint on top of reflective films provided on a glass substrate. Pattern deposition on top of performance films has been followed for many years. However, the reflectivity of the sputtered films on glass compromises the visibility of the design pattern when viewed from the viewing side and therefore leads to a subdued appearance. Patent publication WO 2014/133929 A2, discloses a method of making a coated article, by screen-printing a frit in a desired pattern on a glass substrate supporting a heat treatable thin-film coating, and heat treating the substrate with the thin-film coating and the frit thereon in connection with a first temperature or first temperature range sufficient to (a) cause particles in the frit to migrate downwardly into the thin-film coating and dissolve the thin-film coating in areas lying under the pattern, and (b) fuse the frit directly to the substrate, in the desired pattern, in making the coated article.
(ii) Deposition of an enamel-based paint on glass substrates followed by heat-treatment to fuse enamels and then sputtering of optical films. The deposition of reflective films on top of tempered enamel-patterned glass prevents processing of large glass sheets, since the patterning on the glass sheets require prior washing, cutting and grinding steps. Moreover, processing of cut and tempered sheets leads to productivity challenges during sputtering.
(iii) Deposition of an enamel-based paint on glass substrates followed by sputtering of optical films and then heat-treatment. The sputtering on enamel-patterned glass prior to tempering demands stringent specifications on the green-strength of the enamel to withstand the handling, transport washing and preparation steps prior to sputtering.

Referring to U.S. Patent Publication 20160118619 A1, discloses a glass film including, forming a sacrificial layer on a base substrate; forming a glass frit film on the sacrificial layer; solidifying the glass frit film; and removing the sacrificial layer, so as to obtain a glass film. The sacrificial layer is placed into an acid solution to be dissolved, so that the sacrificial layer is removed.

Referring to U.S. Patent Publication 20190276354 A1, relates to a glass or glass-ceramic substrate comprising both a polymeric coating intended to protect the glass substrate and a durable, good-quality printed logo or pattern that withstands the heat treatment during which the polymeric coating is burnt off.

Referring to U.S. Patent Publication 20150376935 A1, provides techniques for forming decorative patterns on glass substrates. Particularly, the use of a ceramic frit that dissolves an already-applied thin film coating (disposed via physical vapor deposition (PVD) or other suitable process) is provided. However, the publication does not provide any compositions of the thin film coating or a ceramic frit that ensures the dissolution or removal of the thin film coating during heat-treatment. Moreover, as shown in the embodiments, the thin film removal becomes much more inefficient as the thickness of the ceramic frit decreases.

Notwithstanding all the past experience and technology which are available for temporary protection of optical film coated glass substrates, it has been discovered that although these temporary coatings are effective to some extent, they involve lot of drawbacks. The common limitation that is observed in the state of art is the subdued appearance of the patterned enamel when viewed from the viewing side of the glass substrate, thereby decreasing the aesthetics of the decorative patterned glass articles.

Although optical coatings for overcoming the above mentioned drawbacks have been reported, these coating come with additional operational cost. For example, the use of sacrificial films as described in US20160118619A1 requires a separate chemical removal step of the sacrificial film thereby leading to additional process steps and material constraints, thereby not making the process economically feasible. Additionally, fusion of the enamel paint to the underlying glass substrate is also not possible. Also the sacrificial layer described in US20190276354A1 is used to protect the optical film. However, this layer is completely burnt off, during the high temperature treatment. All these processes, however, lead to subdued appearance of the design pattern when viewed from the glass viewing side, thereby decreasing the contrast of the decorative patterned glass article. It is essential to ensure that a good contrast is achieved between the patterned layer and the optical coating to improve the aesthetics of the decorative article and to have an economically viable process for making such an article.

Thus there is a need for developing coatings for providing decorative patterned glass articles that have improved contrast when viewed from the glass viewing side, which is a requirement for aesthetic appeal and for applications in glass market. It is also essential to develop coatings that have enhanced resistance to high temperature treatments like glass tempering. The decorative patterned glass articles proposed as per the present disclosure provides for enhanced appearance of the patterned enamel when viewed the glass side and can be provided in distinct aesthetically appealing colors and shades.

### OBJECT OF INVENTION

The main object of the present invention is to provide a heat treatable decorative patterned glass article, said glass article having a selectively dissolvable coating, and provides excellent contrast to the glass article from the glass side view.

Another object of the invention is to provide a heat treatable decorative patterned glass article, which can withstand the high tempering temperatures during the making of the said glass article.

Yet another object of the invention is to provide a method for making a heat treatable decorative patterned glass article comprising a transparent substrate deposited with coatings in accordance with the disclosure, such coatings including a selectively dissolvable coating that provides excellent contrast to the decorative glass article from the glass side view and also withstands the high tempering temperatures during the making of the patterned glass substrate.

The present disclosure was developed by outlining the above objectives.

### SUMMARY OF THE DISCLOSURE

In one aspect the present disclosure provides a heat treatable decorative patterned glass article comprising: a transparent substrate; a monolayer optical coating deposited over at least one surface of the transparent substrate, and a patterned enamel coating deposited over the optical coating. The monolayer optical coating is applied directly on one surface of the transparent substrate covering its surface area in entirety, and the optical coating is intended to be selectively dissolved in regions underlying the patterned enamel coating during a processing operation of the transparent substrate.

In another aspect of the present disclosure, a method of making a heat treatable decorative patterned glass article is disclosed. The method involves the steps of cleaning a glass substrate having a first surface and a second surface, depositing a monolayer optical coating over at least one surface of the glass substrate, providing a patterned enamel coating over the optical coating in parts, drying in an infrared oven for less than 20 minutes at a temperature of less than 250° C., heat treating the coated glass substrate at a temperature of about 600 to 750° C. and quenching the coated glass substrate to toughen the glass.

The decorative patterned glass article has an improved contrast between the dissolved and undissolved regions of the optical coating and withstands tempering temperatures as high as 750° C.

Other features and aspects of this disclosure will be apparent from the following description and the accompanying drawings.

### BRIEF DESCRIPTION OF THE DRAWINGS

Embodiments are illustrated by way of example and are not limited in the accompanying figures.

FIG. 1 illustrates a cross-sectional view of a transparent substrate, in accordance with one embodiment of the present disclosure.

FIGS. 2 (a) and (c) illustrate a comparative non-heat treated clear and green tinted glass substrates, in accordance with one embodiment of the present disclosure.

FIGS. 2 (b) and (d) illustrate inventive clear and green tinted glass substrate, in accordance with one embodiment of the present disclosure.

FIG. 3 illustrates a graphical representation comparing the specular reflection on a transparent substrate with and without optical coating, in accordance with one embodiment of the present disclosure.

FIG. 4 (a) illustrates a comparative transparent substrate as available in market, in accordance with one embodiment of the present disclosure.

FIG. 4 (b) illustrates inventive transparent substrate, in accordance with one embodiment of the present disclosure.

FIG. 5 illustrates of a method of making a heat treatable decorative patterned glass, in accordance with one embodiment of the present disclosure.

### DETAILED DESCRIPTION

Wherever possible, the same reference numbers will be used throughout the drawings to refer to the same or the like parts. Embodiments disclosed herein are related to a heat treatable decorative patterned glass article and a method for preparing the same according to the teachings of the present disclosure.

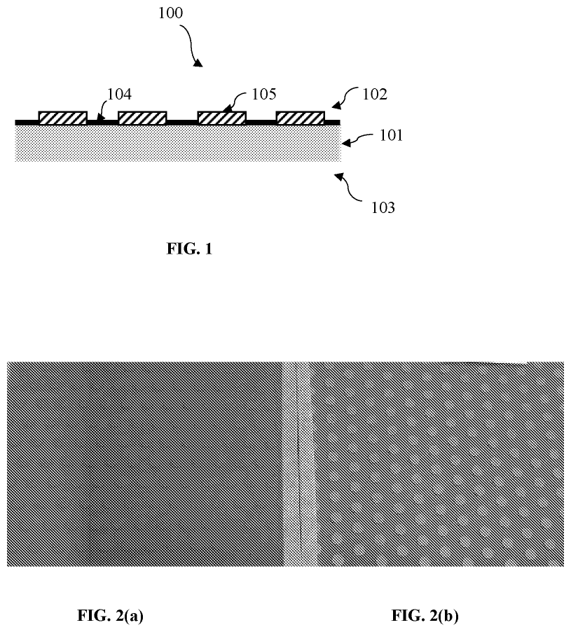

FIG. 1 illustrates a cross-sectional view of a heat treatable decorative patterned glass article 100 in accordance with one embodiment of the present disclosure. As shown, the heat treatable decorative patterned glass article 100 comprises a transparent substrate 101 including a first surface 102 and a second surface 103. As illustrated in FIG. 1, a monolayer optical coating 104 is deposited over at least one surface 102 of the transparent substrate 101. The optical coating 104 is directly provided on one surface of the transparent substrate 101 covering its entire surface area. The optical coating 104 in accordance with the present disclosure is deposited either by chemical vapor deposition or physical vapor deposition means. The techniques of deposition of the optical coating 104 includes but not limited to sputtering, evaporation, atomic layer deposition, plasma enhanced chemical vapor deposition. The optical coating 104 is provided on at least one surface 102 of the transparent substrate 101. The optical coating 104 as deposited on the transparent substrate 101, serves as an aesthetic add-on to the glass substrate 101 and at the same time ensures thermal, visual and acoustic comfort.

The aesthetic appearance of the decorative glass articles is determined by the various reflection and color coefficients or parameters of the coatings that are deposited over any transparent substrate. The coatings that are to be deposited on the transparent substrate are obtained by different ways, specifically, searching for the materials and optimizing them in order to obtain desired optical properties. Other methods include development of coatings based on the interference of different amplitudes reflected in each of the interfaces of the multilayered coatings.

In the present disclosure, the optical coating 104 and the patterned enamel coating 105 are developed to achieve aesthetic aspects of the decorative glass article, after deposition under controlled method over the transparent substrate 101.

The optical coating 104 in accordance with the present disclosure is a single or a monolayer layer. In one embodiment of the present disclosure, the optical coating 104 is a silicon based coating selected from the group comprising but not limited to silicon, silicon oxide, silicon nitride, silicon carbonitride, silicon oxycarbide. etc. In a preferred embodiment the optical coating 104 is a silicon coating. In an alternate embodiment of the present disclosure the optical coating 104 is also selected from the group comprising metallic layers, metallic alloys, metalloids, nitrides, oxides and carbides. In all embodiments of the present invention, the optical coating is free of organic components that pyrolyze below a temperature of 600° C.

The thickness of the optical coating 104 ranges from 1 nm to 300 nm. In a preferred embodiment the thickness of the optical coating 104 ranges from 1 nm to 200 nm, and in a most preferred embodiment the thickness of the optical coating is from 1 nm to 100 nm. In multiple embodiments, the optical coating 104 is substantially a continuous coating, extending across the entire surface area of at least one surface 102 of the transparent substrate 101. The optical coating 104 provided in accordance with the present disclosure are substantially thin coatings. The thickness of the optical coating 104 impacts the dissolution of the optical coating. Thinner the optical coating 104, easier and efficient is the dissolution of the optical coating. The optical coating 104 with the said thickness not only ensures easier dissolution, but also provides better optical properties with respect to contrast and color.

The optical coating 104 has distinct reflection, absorption and/or transmission properties compared to the base glass substrate that results in a visual, thermal or acoustic modification of the performance of the glass substrate. The optical coating 104 is primarily an inorganic based material, which ensures no degradation during high temperature treatment. The inorganic layer does not undergo any chemical or physical transition at high temperatures when not in touch with the patterned enamel coating in accordance with the present invention and therefore retains its optical properties. In one embodiment, the optical coating 104 in accordance with the present disclosure is also chemically resistant to strong acids, bases and solvents.

The heat treatable decorative patterned glass article 100 comprising the transparent substrate 101 in accordance with the present disclosure, is further provided with a patterned enamel coating 105. The patterned enamel coating 105 is deposited directly over the silicon based optical coating 104.

The patterned enamel coating 105 is applied directly on the optical coating 104 covering its surface area in parts using a variety of wet-coating deposition techniques including but not limiting to screen printing, embossed roller coating, digital printing, curtain coating, gravure coating, ink-jetting, spray painting or dip coating. The patterned enamel coating 105 can be provided in any form, size, shape and/or color in such a way that it covers the surface area over the optical coating 104, in parts thus making a patterned design. The patterned enamel coating 105 in accordance with the present disclosure comprises an inorganic component, an organic binder and a solvent medium.

The patterned enamel coating 105 is comprised of inorganic pigments, ceramic frits and a fluorinated compound. In an embodiment, the inorganic pigments are selected from the group comprising but not limited to titanium dioxide, zinc oxide, iron or other metal ion doped titania, copper oxide, chromium oxide, cobalt oxide, lithium niobate, manganates, berilium oxide, cadmium sulfide or cadmium telluride. In a further embodiment, the inorganic frit is a zinc-based frit or a bismuth-based frit or a combination thereof. In a further embodiment, the fluorinated compound is selected from a group of compounds whose melting point is below 750° C. In a specific embodiment, the fluorinated compound is potassium bromofluoride or tin fluoride. In a further preferred embodiment, the fluorinated compound is potassium bromofluoride. The potassium bromofluoride in the coating formulation is present in the range of 0 to 15 wt %.

The inclusion of the potassium bromofluoride in the patterned enamel coating 105 improves the removal of the optical coating 104, which is usually indicated by b* values which is much closer to zero. The use of such fluorinated additives in accordance with the present invention allow for the use of this invention at thickness much lower than a conventional enamel formulation.

In an embodiment, the inorganic pigment in the coating formulation is present in the range of 10 to 50 wt %. In a preferred embodiment the inorganic component in the enamel coating is present in the range of 10 to 40 wt %.

The patterned enamel coating 105 further comprises organic binder selected from the group consisting of acrylates, esters, acrylic esters, epoxies, polyols, urethanes, silicones, melamine and their combinations thereof. In an embodiment the organic binder in the enamel formulation is present in the range of 2 to 40 wt %. In a preferred embodiment the organic binder in the enamel coating is present in the range of 2 to 20 wt %.

The patterned enamel coating 105 further comprises solvent selected from the group consisting of di-acetone alcohol, ether glycol, xylene or ethyl methyl ketone. In an embodiment the solvent is present in the range of 10 to 50 wt %. In a preferred embodiment the solvent in the enamel coating is present in the range of 10 to 30 wt %.

The thickness of the patterned enamel coating 105 ranges from 1 to 200 μm. In a preferred embodiment the thickness of the patterned enamel coating 105 ranges from 10 to 100 μm, and in a most preferred embodiment the thickness of the enamel coating ranges from 10 to 50 μm. The patterns printed on the optical coating 104 are selected from the various patterns including but not limited to logos, lines, polka dots, circles, square, triangle, oval, rectangle, octagon, parallelogram, trapezoid, pentagon, hexagon, stars, gradients, abstract shapes or a combination thereof, with varying diameters and depths. The surface area to be covered by the patterned enamel coating 105 in the present disclosure is varied based on the requirement and shape of the pattern.

In order to achieve good contrast and improved aesthetic appearance of the patterned enamel, the optical coating 104 in accordance with the present disclosure is selectively dissolved, that is only in regions that is underlying the patterned enamel coating 105. This selective dissolution of the optical coating 104 is achieved during a processing operation of the transparent substrate 101 where the transparent substrate 101 is heat treated and the patterned enamel coating 105 is fused onto the transparent substrate 101. The glass frit present in the enamel fuses with the transparent substrate 101 after the dissolution of the optical coating 104 underlying the patterned enamel coating 104.

The selectively dissolved region of the optical coating 104 therefore comprises only a fused enamel layer after the processing operation. The extent of the selective dissolution is indicated by the fraction of the optical coating remaining on the transparent substrate. In a system where the optical coating has been completely removed, the specular reflection and the b* parameters defined in the embodiments are equivalent to the measurements taken on systems not having any optical coatings in the first place.

Several factors like the required heating time, the composition, thickness of glass, optical coating and the enamel coating all play a vital role to ensure that the complete dissolution of the optical coating underlying the patterned enamel coating is achieved The substrate temperatures also play a role in influencing dissolution. A complete dissolution of the underlying optical coating 104 is ensured by increasing glass thickness, glass tints, absorption of the optical coating and the enamel coating, and residence time in the furnace to attain the temperatures needed for complete coating dissolution.

In an embodiment the processing operation is heat treating the transparent substrate 101 at a temperature as high as ranging from 600° C. to 750° C. The optical coating 104 according to the present disclosure interacts and dissolves in the enamel coating 105 during the high temperature treatment. The silicon based monolayer optical coating 104 that is not overlaid with patterned enamel coating 105 not only withstands high temperature, but is also resistant to corrosive washing media like acids and bases also to organic solvents.

Generally, at high temperatures, coatings including thin films, optical coatings, enamel coatings etc., tend to become more mobile due to displacement of atoms or molecules present. The optical coating used in the present disclosure expands when undergoing the heat treatment, and the regions where the optical coating 104 is not in contact with the patterned enamel coating, acts as a temporary more porous layer which then drops back to its original state after the temperature is brought down. Regions where the optical coating 104 is in contact with the patterned enamel coating 105, the increased porosity of the optical coating 104 and the fluidity of the patterned enamel coating 105 during fusion results in inter-diffusion. There is a diffusion of the enamel layer into the optical film, and owing to the low thickness of the optical coating 104 as compared to the patterned enamel coating 105, the optical coating 104 loses its characteristic visual appearance. This process in accordance with the present disclosure leads to selective dissolution of the optical coating, which withstands high temperature and also ensures good contrast of the glass article. In accordance with the present invention the presence of the fluorinated compound in the enamel coating ensures more efficient removal of the silicon based monolayer optical coating. In the presence of the fluorinated compound, the removal of the optical coating is found to be complete as shown in Table 4, especially at low enamel coating thickness. Moreover, a multilayer coating has also been observed to be difficult to be removed with the enamel coatings as opposed to a monolayer coating.

In accordance with the present disclosure the patterned glass article 100, thereby has an improved contrast between the dissolved and undissolved regions of the optical coating 104. The optical coating 104 in an embodiment is optically distinct from glass substrate. The optical coating 104 has distinct reflection, absorption and/or transmission properties compared to a base glass substrate that results in a visual as well as thermal or acoustic modification of the performance of the base glass substrate. This distinction achieves greater contrast of the glass substrate. The appearance of the enamel pattern post the heat treatment is enhanced when viewed through the glass side and a contrast in appearance is obtained between the dissolved patterned regions and undissolved regions of the optical coating.

The contrast that is achieved according to the teachings of the present invention is quantified using certain parameters such as gloss, specular reflection values and b*. The extent of the dissolution or removal of the optical coating used in the present disclosure are indicated via the b* colour parameter in the CIELAB colour space. The b* parameter varies from −128 to 128 indicating a shift from blue to yellow. A value of indicates a neutral appearance The pristine thin film coatings have a positive b* value indicating a yellowish appearance. The change in the b*value is tracked post-tempering. A value close to zero indicates a complete removal of the thin film coating and signifies the completion of the dissolution process. In multiple embodiments of the present disclosure, various combinations of patterns and different enamel colors can be used without limiting to white color enamel.

The present invention also provides a method for making the heat treatable decorative patterned glass article 100 as disclosed in FIG. 5. The method comprises the steps of cleaning the surface of the glass substrate to remove dust and other contaminations including finger prints. The glass substrate in accordance with the present invention has at least one surface, one first surface 102 and a second surface 103. The silicon based monolayer optical coating 104 is then deposited on the first surface of the cleaned glass substrate to cover the entire surface area, using chemical vapor deposition (CVD), sputtering, evaporation, wet-coating techniques technique. In a preferred embodiment the optical coating 104 is deposited using CVD. The thickness of the optical coating 104 ranges between 1 to 300 nm.

The glass substrate deposited with the optical coating 104 on the first surface 102, is further provided with a patterned enamel coating 105 as illustrated in FIG. 5. The patterned enamel is coated over the optical coating 104 by various printing techniques commonly used in the state of art. The printing techniques in accordance with the present disclosure include screen printing, embossed roller coating, digital printing, curtain coating, gravure coating, ink-jetting, spray painting or dip coating. In a preferred embodiment the patterned enamel coating 105 is deposited using screen printing or roller coating. In an embodiment of the present disclosure the patterned enamel coating 105 does not cover the entire surface area of the optical coating 104. It is only provided in parts to cover the optical coating 104, depending on the pattern that is being deposited. The patterned enamel coating 105 in all embodiments of the present disclosure, can be provided in any form, size, shape or color in such a way that it covers the surface area over the optical coating 104, only in parts. In some embodiments the patterned enamel coating 105 covers at least minimal portion of the surface area of the optical coating. The thickness of the patterned enamel coating 105 ranges between 1 μm to 200 μm. The glass transition temperature Tg of the patterned enamel is in the range of 400 to 700° C.

The method further comprises drying the glass substrate deposited with the optical coating 104 and patterned enamel coating 105, in an infrared oven for less than 20 minutes at a temperature less than 250° C. The coated glass substrate 101 is then subjected to heat treatment at a temperature of about 600 to 750° C., followed by quenching in order to toughen the glass. During this heat treatment process the optical coating 104 is selectively dissolved in regions underlying the patterned enamel coating 105, and the optical coating 104 in contact with the patterned enamel coating 105 is completely dissolved. The decorative patterned glass article 101 according to the present disclosure has an improved contrast between the dissolved and undissolved regions of the optical coating 104 when viewed from the glass side.

The patterned coated glass substrate thus obtained has a specular reflection of the transparent substrate is in the range of 70 to 93 gloss units, and b* value of as less as −0.12. The decorative patterned glass article 101 according to the present disclosure has an improved contrast between the dissolved and undissolved regions of the monolayer optical coating 104 when viewed from the glass side.

### EXAMPLES

Following examples are given by way of illustration therefore should not be construed to limit the scope of the invention.

### Preparation of Heat Treatable Transparent Substrate

Heat treatable clear glass substrate and green tinted glass substrate prepared according to the teachings of the present disclosure were compared with glass substrates without optical coating & non-heated glass substrates. Gloss value, relative whiteness and specular reflection of all the samples were measured.

### Inventive Sample A1:

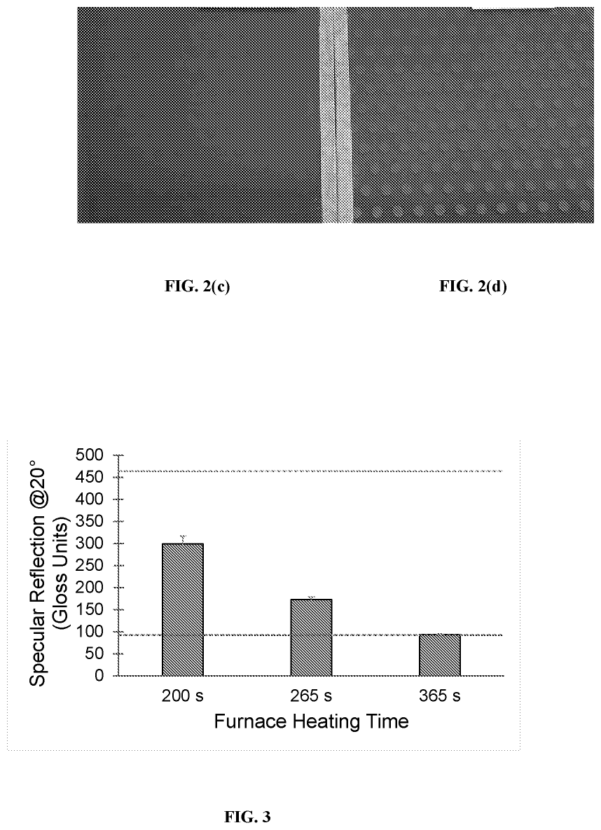

Sample A1 is prepared in accordance with the present disclosure. FIG. 2(b) discloses Sample A1, which is prepared following the steps produced below:
1) Cleaning a clear glass substrate having a first surface and a second surface. The clear glass substrate has a thickness of 6 mm.
2) Depositing an optical coating over one first surface of the clear glass substrate. The optical coating has a thickness of about 30-50 nm.
3) Providing a polka dot patterned enamel coating over the optical coating to cover around 20% of surface area
4) Drying in an infrared oven for less than 20 minutes at a temperature of less than 250° C.
5. Heat treating the coated clear glass substrate at a temperature of about 600 to 750° C. to obtain a glass substrate.
6) Quenching the obtained coated clear glass substrate to toughen the glass.

### Inventive Sample A2:

Sample A2 is prepared in accordance with the present disclosure. FIG. 2(d) discloses Sample A2, which is a green tinted glass prepared similar to the steps as stated above for Sample A1.

### Comparative Sample B1 & B2:

Sample B1 (FIG. 2(a)) is a comparative clear glass substrate which was not heat treated, similarly sample B2 (FIG. 2(c)) is also a comparative green tinted glass substrate which was not heat treated.

The above samples were accordingly compared respectively, for the contrast that is achieved.

### Inference:

FIGS. 2(b) and 2(d) clearly illustrates images showing a patterned enamel deposited on an optical coating on a clear glass and a green tinted glass. The coated glass substrates subsequently undergone heat treatment. The coated glass substrates according to the present invention are compared over the non-heated glass substrates 2(a) and 2(c) with patterned enamel coating. The images 2(a) and 2(c) clearly indicate the pattern's visibility is subdued initially before heat-treatment due to the high-reflectivity of the silicon film. Post heat-treatment in the furnace, the optical film is removed in regions in contact with the enamel, thereby improving the visibility of the deposited pattern, as seen in images 2(b) and 2(d).

FIG. 3 illustrates a chart demonstrating the specular reflection values on substrates with an optical coating and patterned enamel coating as a function of furnace time during heat treatment. Two reference lines are also indicated: (a) Specular reflection values on optical coating+patterned enamel coating without any heat-treatment (b) Specular reflection values on substrate having patterned enamel coating only with heat-treatment.

It is demonstrated from FIG. 3 that specular reflection measurement as a tool to estimate optical film dissolution during the heat treatment. Enamel paint is deposited on an optical film on a tinted glass substrate. FIG. 3 shows the variation of the specular reflection at 20° incidence measured via a gloss meter through the glass side. As shown in the figure, the combination of the optical film+enamel paint has a specular reflection value of around 463 gloss units before heat treatment. During the high-temperature heat treatment, the specular reflection values decrease with an increase in the residence time in the furnace. This reduction in the specular reflection values is an indication of the dissolution of the optical film. Eventually, for a residence time of 365s, the specular reflection values are found to be similar to those obtained on enamel paints deposited directly on the glass sheets without any optical film (˜92 gloss units). This indicates near-complete dissolution or removal of the optical layer.

### Gloss Measurements

The gloss value of the heat treatable decorative patterned glass articles prepared according to the present disclosure was measured using a gloss meter with 20° incidence angle and the values are shown in table 1.

TABLE 1
Gloss Value of Glass Substrates

| | Samples | | Samples | |
|---|---|---|---|---|
| | BH | AH | BH | AH |
| | (FIG. 2a) | (FIG. 2b) | (FIG. 2c) | (FIG. 2d) |
| | Comparative | Inventive | Comparative | Inventive |
| Tests | Sample B1 | Sample A1 | Sample B2 | Sample A2 |
| Average | 682 GU | 70 GU | 463 GU | 93 GU |
| gloss | | | | |

*BH—Before heating;
*AH—After heating

Gloss values are used here as indicative measurements of the specular reflection values from the optical coating, when measured on the glass side of the samples. At an incidence/reflection angle of 20°, higher gloss values indicate a more substantial presence of the optical coating. As the degree of heat treatment increases, the gloss values in regions that are underneath the enamel are observed to decrease, indicating the removal or dissolution of the optical coating.

The above table 1 shows the specular reflection expressed in gloss units on the clear and green-tinted glass substrates before and after the heat treatment exposure to temperatures in excess of 600° C. In both cases, observed is a significant reduction in the gloss values as a function of heat treatment.

While the decrease in the specular reflection values as a function of heat treatment is observed to be necessary to remove the optical coating, however this may not be a sufficient condition to ensure an acceptable removal of the optical coating for a good visibility or contrast of the patterned enamel layer. The extent of the dissolution or removal of the optical coating used in the present disclosure are indicated via the b* colour parameter in the CIELAB colour space. The b* parameter varies from −128 to 128 indicating a shift from blue to yellow. A value of 0 indicates a neutral appearance The pristine thin film coatings have a positive b* value indicating a yellowish appearance. The change in the b*value is tracked post-tempering. A value close to zero indicates a complete removal of the thin film coating and signifies the completion of the dissolution process.

### Inventive Sample A3:

A monolayer optical coating of silicon is deposited on a clear glass substrate followed by white enamel paint and then dried in an IR oven at around 180° C.-200° C. for about minutes. The targeted dry film thickness of the coating is around 80-90 μm. The substrate was then heat-treated in a tempering furnace with temperatures exceeding 600° C. to fuse the glass fits in the enamel paint, followed by rapid quenching to toughen the glass.

### Comparative Sample A3:

A tri-layer coating film stack of silicon nitride, niobium nitride and silicon nitride are deposited on a clear glass substrate. The white enamel paint is then deposited on the thin-film coated substrates and then dried in an IR oven at around 180° C.-200° C. for about 15 minutes. The targeted dry film thickness of the coating is around 80-90 μm. The substrates were then heat-treated in a tempering furnace with temperatures exceeding 600° C. to fuse the glass frits in the enamel paint, followed by rapid quenching to toughen the glass.

Table 2 below compares the b* value of a monolayer optical coating and a trilayer coating film stack.

TABLE 2
b* values

| | Film | |
|---|---|---|
| S. No. | description | b* |
| 1 | Inventive | 0.27 |
| | Sample A3 | |
| 2 | Comparative | 2.21 |
| | Sample A3 | |

### Inference:

For the above table, post-tempering or after heat treatment, it is observed that the inventive sample A3, having a monolayer silicon coating (optical coating) shows almost complete removal of the optical coating underlying the patterned enamel layer, resulting in a b* value of about 0.27, which is close to the appearance of a white enamel paint directly on the glass substrate without any thin film. However, the comparative sample A3, having a tri-layer film a value beyond 2, still indicating a significant presence of the coating.

The effect of the thickness of the patterned enamel on the removal of the optical coating deposited on the transparent substrate is studied. The patterned enamel layer is deposited at different targeted dry film thicknesses as described above. As shown in the Table 3, as the thickness of the patterned enamel layer decreases, the b* parameter increases indicating an incomplete removal of the optical coating. This dependence on the thickness of the patterned enamel layer on the optical coating removal suggests a minimum requirement on the quantity of the enamel layer deposition, thereby limiting the effectiveness of this enamel formulation at lower thicknesses.

TABLE 3
Thickness of patterned enamel layer

| | Dry Film | |
|---|---|---|
| S. No. | Thickness (um) | b* |
| 1 | 85 | 0.27 |
| 2 | 75 | 0.25 |
| 3 | 55 | 0.95 |
| 4 | 40 | 3.07 |
| 5 | 32 | 4.06 |

### Inventive Sample A4:

As described in the present disclosure a fluorinated compound is included in the enamel layer. Potassium bromofluoride (KBF₄) is used at a 10 wt. % concentration. The enamel coatings are deposited with a targeted dry film thickness of around 30 μm. After the high temperature treatment, the b* values on these coatings are compared as shown in Table 4.

TABLE 4

| | Patterned Enamel | |
|---|---|---|
| S. No. | formulation | b* |
| 1 | Inventive | −0.12 |
| | Sample A4 | |

### Inference:

From the above table, it is clear that the use of the fluorinated additive is observed to improve the removal of the optical coating as indicated by b* values that are much closer to zero. The use of such fluorinated additives allow for the use of the invention in accordance with the present disclosure even at a thickness much lower than an enamel formulation without the fluorinated compound additive.

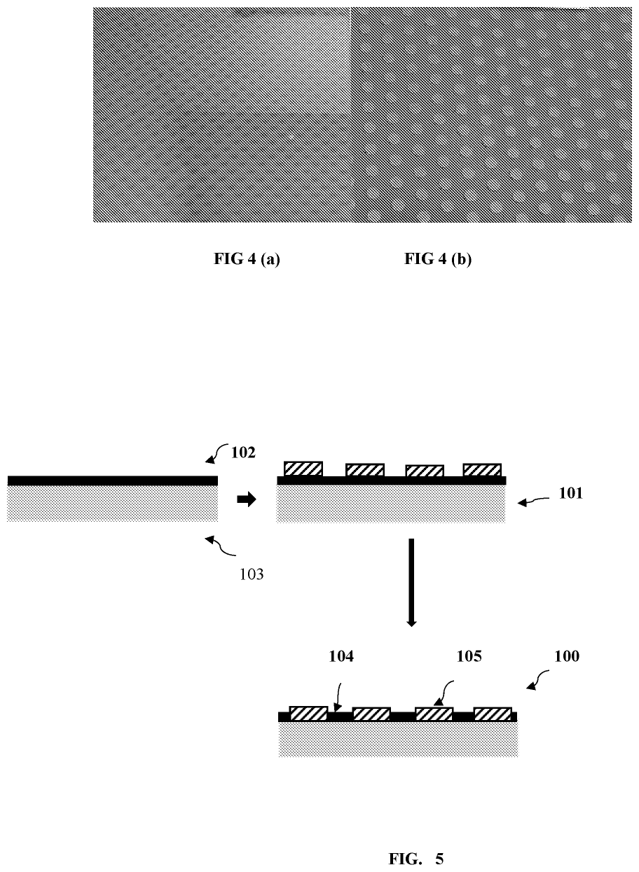

FIG. 4(a) illustrates a pattern deposited on top of a performance film, which is a conventional state of art existing in the market. It is clearly seen from the image that the reflectivity of the sputtered films on glass compromises the visibility of the design pattern from the viewing side and thereby leading to a subdued appearance. FIG. 4(b) clearly illustrates the heat treatable decorative patterned glass article prepared in accordance with the present disclosure, having excellent contrast between the patterned enamel coating and the optical coating. Thus the heat treatable transparent substrate 100 of the present disclosure is very unique with exceptionally excellent contrast when viewed from the glass side, highly resistant to temperatures ranging up to 750° C. and can be used in handling & processing of large glass sheets, thereby limiting productivity losses and material losses involved in the processing of cut glass sheets.

The patterned glass substrate according to this disclosure may have various applications. The patterned decorative article obtained in accordance with the present disclosure may, for example be used for various interior applications of buildings including but not limited to wardrobes, as doors and windows for furniture, as partitions, in tables, shelves, in bathrooms, in shops displays, as wall covering or as spandrels. Such patterned glass substrates 100 may also be used for decorative purposes as not limiting to a wall mount in office spaces, lift lobbies, receptions, kitchens, bathrooms and could also be possibly used as dinning and coffee table surfaces. More and more of these applications necessitate the glass article to achieve both aesthetic appeal to customers, and functional performance.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

The description in combination with the figures is provided to assist in understanding the teachings disclosed herein, is provided to assist in describing the teachings, and should not be interpreted as a limitation on the scope or applicability of the teachings. However, other teachings can certainly be used in this application.

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent that certain details regarding specific materials and processing acts are not described, such details may include conventional approaches, which may be found in reference books and other sources within the manufacturing arts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

### LIST OF ELEMENTS

100—Heat Treatable Decorative Patterned glass article
101—Transparent substrate
102—First surface and Glass side view
103—Second surface
104—Optical coating
105—Patterned enamel coating

1. A heat treatable decorative patterned glass article comprising:
a transparent substrate;
a monolayer optical coating deposited over at least one surface of the transparent substrate;
a patterned enamel coating deposited over the monolayer optical coating;
wherein,
the monolayer optical coating is applied directly on one surface of the transparent substrate covering its surface area in entirety; and
the monolayer optical coating is intended to be selectively dissolved in regions underlying the patterned enamel coating during a processing operation of the transparent substrate, and wherein the decorative patterned glass article has an improved contrast between the dissolved and undissolved regions of the monolayer optical coating.

2. The heat treatable decorative patterned glass article as claimed in claim 1, wherein the monolayer optical coating is a silicon-based coating selected from the group consisting of silicon, silicon oxide, silicon nitride, and silicon carbonitride.

3. The heat treatable decorative patterned glass article as claimed in claim 1, wherein the patterned enamel coating comprises ceramic frits, inorganic pigments and a fluorinated compound.

4. The heat treatable decorative patterned glass article as claimed in claim 1, wherein the patterned enamel coating comprising the fluorinated compound is selected from the group consisting of potassium bromofluoride and tin fluoride.

5. The heat treatable decorative patterned glass article as claimed in claim 1, wherein a thickness of the monolayer optical coating ranges from 1 nm to 300 nm.

6. The heat treatable decorative patterned glass article as claimed in claim 1, wherein the patterned enamel coating is applied directly on the monolayer optical coating covering its surface area in parts.

7. The heat treatable decorative patterned glass article as claimed in claim 1, wherein a thickness of the patterned enamel coating ranges from 1 μm to 200 μm.

8. The heat treatable decorative patterned glass article as claimed in claim 1, wherein the patterned enamel coating fuses with the surface of the transparent substrate in the dissolved regions of the monolayer optical coating.

9. The heat treatable decorative patterned glass article as claimed in claim 1, wherein the processing operation of the transparent substrate is heat treatment at temperatures ranging between 600° C. to 750° C.

10. A method for making a heat treatable decorative patterned glass article as claimed in claim 1, comprising:
cleaning a glass substrate having a first surface and a second surface;
depositing a monolayer optical coating over at least one surface of the glass substrate;
providing a patterned enamel coating over the monolayer optical coating in parts;
drying the coated glass substrate in an infrared oven for less than 20 minutes at a temperature of less than 250° C.;
heat treating the coated glass substrate at a temperature of about 600° C. to 750° C.; and
quenching the heat treated glass substrate;
wherein,
the monolayer optical coating is applied directly on one surface of the transparent substrate covering its surface area in entirety; and
the monolayer optical coating, during the heat treating of the coated glass substrate is selectively dissolved in regions underlying the patterned enamel coating to provide an improved contrast between the dissolved and undissolved regions of the monolayer optical coating.

11. The method as claimed in claim 10, wherein the step of depositing the monolayer optical coating is done by chemical vapor deposition (CVD).

12. The method as claimed in claim 10, wherein, during the heat treating, the monolayer optical coating in contact with the patterned enamel coating is completely dissolved.

13. The method as claimed in claim 10, wherein the patterned enamel is applied over the monolayer optical coating by screen printing, embossed roller coating, digital printing, curtain coating, gravure coating, ink-jetting, spray painting or dip coating.
